(19) United States
(12) Patent Application Publication
(10) Pub. No.: US 2017/0118960 A1
(43) Pub. Date: May 4, 2017

(54) Dog Leash and Tether

(71) Applicant: Maki Yuinada, Phoenicia, NY (US)

(72) Inventor: Maki Yuinada, Phoenicia, NY (US)

(21) Appl. No.: 14/928,226

(22) Filed: Oct. 30, 2015

Related U.S. Application Data
(60) Provisional application No. 62/247,927, filed on Oct. 29, 2015.

(51) Int. Cl. A01K 27/00

(52) U.S. Cl. CPC A01K 27/003

(57) ABSTRACT

The present invention provides a dog leash that converts to a tether. The dog leash generally includes an elongated strap of flexible material, such as fabric webbing, having a clip at one of its ends that is adapted to clip onto a ring that is attached to a dog's collar; a male fastening element fixedly secured to the opposite end of the strap; and a female fastening element mounted for selective adjustment along the length of the strap.

### REFERENCE TO RELATED APPLICATION

The present application relates and claims priority to U.S. patent application No. 62/247,927 filed on Oct. 29, 2015, the entirety of which is hereby incorporated by reference.

### BACKGROUND

1. Field of Invention

The present invention relates to a dog leash, and more particularly to a dog leash that can be converted into a tether.

2. Background of Art

Walking a dog on a lead or leash is a safe, and in many places, legally required means for exercising one's pet. In urban locations in particular, people often walk their dogs whenever running an errand since walking is a common mode of transportation. However, due to most business establishments having rules that prevent dogs from entering, the owners will have to tie the dog to a post, tree, or other stable object. This likewise applies to those who walk their dogs but then simply want to take a break from the walk and not continue holding on to the leash.

When tying the dog off to a tree, post or other stable object, the leash is typically wrapped around the object and the clip that attaches the leash to the dog's collar is passed through the leash's handle to form a loop and then reattached to the dog's collar in order to tether the dog to the object.

3. Objects and Advantages

It is a principal object and advantage of the present invention to provide a dog leash that can easily convert to a tether.

It is another object and advantage of the present invention to provide a dog leash that can easily convert to a tether of varying size.

Other objects and advantages of the present invention will in part be obvious and in part appear hereinafter.

### SUMMARY OF THE INVENTION

In accordance with the foregoing objects and advantages, the present invention provides a dog leash that converts to a tether. The dog leash generally comprises an elongated strap of flexible material, such as fabric webbing, having a clip at one of its ends that is adapted to clip onto a ring that is attached to a dog's collar; a male fastening element fixedly secured to the opposite end of the strap; and a female fastening element mounted for selective adjustment along the length of the strap. When walking a dog, the female fastening element can be slid along the strap to a position appropriate for forming a handle and the male fastening element can be engaged with the female fastening element to form the handle. When wanting to tether the dog a tree, post or other object, the fastening elements can be disconnected, the female fastening element slid along the length of the strap such that the strap may encircle the tree, post or other object, and then the male fastening element can be reengaged with the male fastening element to secure the strap to the tree, post or other object. The tethering can be accomplished without ever releasing the leash from the dog's collar.

In one aspect of the invention, a method for tethering a pet to a fixed structure having a predetermined diameter is provided. The method generally comprises the steps of: (1) securing the pet to the first end of an elongated leash using a first fastener attached to the first end; (2) adjusting the position of a first member of a second fastener along the length of the elongated leash until it is positioned a distance at least as great as the length of the periphery of the fixed structure from the second end of the elongated leash; and (3) wrapping the second end of the elongated leash around the fixed structure and engaging the first member of the second fastener to a second member of the second fastener, whereby the second end of the elongated leash is securely tethered to the fixed structure.

### BRIEF DESCRIPTION OF THE DRAWINGS

The present invention will be more fully understood and appreciated by reading the following Detailed Description in conjunction with the accompanying drawings, in which:

FIG. 1 is a perspective view of the present invention; and

FIG. 2 is a perspective view of the present invention attached to a tree.

### DETAILED DESCRIPTION

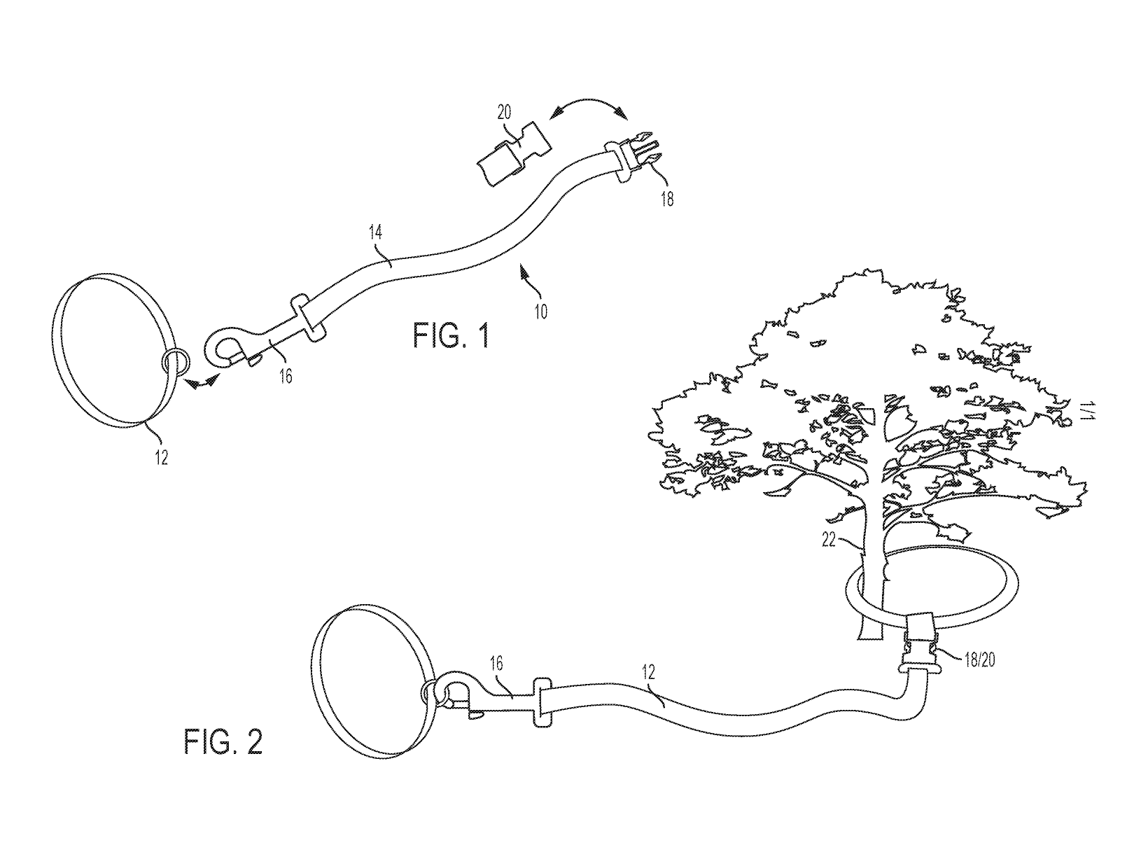

Referring now to the drawings, there is seen on FIG. 1 a dog leash, designated generally by reference numeral 10, for attaching to a dog's collar 12. Dog leash 10 essentially comprises an elongated strap 14 composed of material typically used in the construction of dog leashes (e.g., a fabric webbing, leather strap, etc.), a clip 16 fixed to one end of the strap 14 and used to secure the strap to the dog's collar 12, a first fastening element 18 fixed to the opposite end of strap 14, and a second fastening element slidably mounted at an intermediate position along strap 14 for selective movement there along. First fastening element 18 and second fastening element 20 can be male and female connectors, snap type connectors, or other conventional fastening elements that can be fastened and released relative to one another.

In use, a dog walker would simply connect the leash 10 to the dog's collar 12 in the typical fashion (e.g., by securing clip 16 to the dog's collar 12) in order to walk the dog on the leash. When done walking the dog and wanting to tether the dog to a tree, post or other object 22 (for simplicity this will simply be referred to as a “tree”), the clip 1 would remain fixed to the dog's collar 12, and the first fastening element 18 would be released from second fastening element 20, second fastening element 20 would be slid to a position along strap 14 that is suitable for wrapping strap 14 around tree 22, and then the first and second fastening elements 18, 20 are reengaged with one another to secure the leash 10 to tree 22 while at all times maintaining the dog on the leash 10.

What is claimed is:

1) A combination dog leash and tether, comprising:
a) an elongated strap having first and second terminal ends;
b) a first fastener attached to said first end adapted to engage with a dog's collar; and
c) a second fastener, comprising:
i) a first member attached to said second end; and
ii) a second member mounted for selective sliding movement along the length of said strap between said first and second terminal ends and being releasably connectable to said first member.

2) The combination dog leash and tether according to claim 1, wherein said elongated strap is composed of webbing.

3) The combination dog leash and tether according to claim 1, wherein said first fastener member is a spring loaded clip.

4) The combination dog leash and tether according to claim 1, wherein said first member is a male clip and said second member is a female clip adapted for secure engagement with said male clip.

5) The combination dog leash and tether according to claim 1, wherein said first member is a female clip and said second member is a male clip adapted for secure engagement with sale female clip.

6) The combination dog leash and tether according to claim 1, wherein said first and second members are male and female snaps, respectively.

7) A method for tethering a pet to a fixed structure having a predetermined diameter, comprising the steps of:
a) securing the pet to the first end of an elongated leash using a first fastener attached to said first end;
b) adjusting the position of a first member of a second fastener along the length of the elongated leash until it is positioned a distance at least as great as the length of the periphery of the fixed structure from the second end of the elongated leash; and
c) wrapping the second end of the elongated leash around the fixed structure and engaging the first member of the second fastener to a second member of the second fastener, whereby said second end of the elongated leash is securely tethered to the fixed structure.
